(19) United States
(12) Patent Application Publication
(10) Pub. No.: US 2025/0088294 A1
(43) Pub. Date: Mar. 13, 2025

(54) MONITORING OF AUTOMATED FREQUENCY COORDINATION NETWORK TO DETECT AND MITIGATE SUCCESSIVE INTERFERENCE

(71) Applicant: Cisco Technology, Inc., San Jose, CA (US)

(72) Inventors: Sachin D. WAKUDKAR, St-Sulpice (CH); Evgeny YANKEVICH, Beachwood, OH (US); Ardalan ALIZADEH, Milpitas, CA (US); Peiman AMINI, Fremont, CA (US); Arya FALLAHI, Oberengstringen (CH)

(21) Appl. No.: 18/466,612

(22) Filed: Sep. 13, 2023

(51) Int. Cl. H04B 17/345; H04B 17/309

(52) U.S. Cl. CPC H04B 17/345; H04B 17/347

(57) ABSTRACT

Systems and techniques for mitigating interference to incumbent users in a wireless network are described. An example technique includes receiving an indication of interference on a channel that an incumbent user within a wireless network is operating on. A source of the interference is determined using key performance indicator(s), in response to the indication. A set of actions is determined and performed to mitigate the interference. Another example technique includes receiving an indication of interference on a channel that an incumbent user within a wireless network is operating on. Interference information is obtained from a controller associated with the wireless network and includes KPI(s) associated with a set of access points (APs) operating on the channel. A source of the interference is determined based on the interference information. A set of actions to mitigate the interference are determined and performed on one or more of the set of APs.

### TECHNICAL FIELD

Embodiments presented in this disclosure generally relate to wireless communications. More specifically, embodiments disclosed herein relate to techniques for mitigating interference to incumbents in a wireless network.

### BACKGROUND

A variety of wireless systems use or rely on coordination between systems (or at least awareness of other systems) to mitigate or avoid interference. Such cooperation may be particularly important when different wireless systems use overlapping spectrum. For example, incumbent networks (e.g., licensed cellular networks) may use frequencies that overlap with WiFi access points (APs) using the 6 gigahertz (GHz) band. Automated frequency coordination (AFC) is one approach used to mitigate or prevent interference between such systems. Generally, AFC involves reliance on a database of registered spectrum use (e.g., the bands used in a given area), where other systems (e.g., wireless local area network (WLAN) APs) consult the database to determine whether its operations may interfere with preexisting use (e.g., with cellular networks).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A depicts an example system, according to one embodiment.

FIG. 1B depicts another example system, according to one embodiment.

FIG. 2 is a flowchart of a method for mitigating interference to incumbents in a wireless network, according to one embodiment.

FIG. 3 is a flowchart of another method for mitigating interference to incumbents in a wireless network, according to one embodiment.

FIG. 4 illustrates an example computing device, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method. The computer-implemented method includes receiving an indication of interference on a channel that an incumbent user within a wireless network is operating on. The computer-implemented method also includes, in response to the indication, determining a source of the interference using one or more key performance indicators (KPIs). The computer-implemented method further includes determining a set of actions to mitigate the interference. The computer-implemented method further includes performing the set of actions.

Another embodiment described herein is a computing device. The computing device includes one or more memories and one or more processors communicatively coupled to the one or more memories. The one or more processors are collectively configured to perform an operation. The operation includes receiving an indication of interference on a channel that an incumbent user within a wireless network is operating on. The operation also includes, in response to the indication, determining a source of the interference using one or more key performance indicators (KPIs). The operation also includes determining a set of actions to mitigate the interference. The operation further includes performing the set of actions.

Another embodiment described herein is a computer-implemented method. The computer-implemented method includes receiving an indication of interference on a channel that an incumbent user within a wireless network is operating on. The computer-implemented method also includes obtaining interference information for the wireless network from a controller associated with the wireless network, the interference information comprising one or more key performance indicators (KPIs) associated with a set of access points (APs) operating on the channel. The computer-implemented method also includes determining a source of the interference, based on the interference information. The computer-implemented method further includes determining a set of actions to mitigate the interference and performing the set of actions on one or more of the set of APs.

Other embodiments provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein.

### Example Embodiments

Wireless communication standards, such as the Institute of Electrical and Electronics Engineers (IEEE) 802.11 technical standard, are continuing to evolve to meet the ever increasing demands of bandwidth intensive and low latency services, such as augmented/extended reality and cloud gaming, as illustrative, non-limiting examples. For example, WiFi 6E, which is an extension to IEEE 802.11ax (also known as WiFi 6), includes 1200 megahertz (MHz) of contiguous spectrum that provides seamless coverage across multiple unlicensed national information infrastructure (U-NII) bands, such as U-NII-5, U-NII-6, U-NII-7, and U-NII-8.

WiFi 6E generally defines four separate access classes for WiFi, each with its own rules: (i) standard power (indoor/outdoor); (ii) low power (indoor); (iii) very low power/portable (indoor/outdoor); and (iv) clients (indoor/outdoor). For certain access classes (e.g., standard power), devices (e.g., APs) may have to coordinate with an AFC service/system/operator to determine whether the device is allowed to operate in a desired band, such as the 6 GHz band. For example, there may be one or more incumbent (licensed) users operating in one or more WLAN channels in the 6 GHz band. Such incumbent users may include fixed service(s), satellite service(s), television broadcast service(s), and existing unlicensed users, as illustrative, non-limiting examples. To reduce chances of interference with an incumbent, standard power access generally requires that APs be coordinated through an AFC service/system/operator.

In such a system, each AP may query the AFC service/system/operator in order to evaluate its own use. The AFC service/system/operator may access a database of all licensed users (e.g., Federal Communications Commission Universal Licensing System (ULS)) and use the AP's geographical location and antenna characteristics to create a topographical propagation map modeling the AP's interference radius. The topographical propagation map may then be used to coordinate and assign power and channel settings that avoid interference with the incumbent users in the band.

However, one issue with current AFC systems is that, in situations where an incumbent user reports interference to an AFC system, the AFC system may not be able to identify which AP(s) are causing the interference and to take action to mitigate interference from the identified AP(s). For example, while current AFC systems may indicate available channels and power levels to individual APs, such AFC systems may not have visibility to which particular channels are being used by a given AP. In some cases, this lack of granular visibility as to the particular interference source may lead to the AFC system needlessly pulling down all APs in the geographical area regardless of whether the APs are causing the interference to the incumbent user. Consequently, the AFC system's mitigation action, in response to detected interference, can impact the entire network for multiple AFC operators, reducing the performance of the network in terms of throughput and latency, as illustrative, non-limiting examples.

To address this, embodiments described herein provide improved systems and techniques for mitigating interference to incumbents in a wireless network. More specifically, embodiments described herein provide techniques that allow an AFC controller, AFC operator, or a combination thereof, to determine the source of interference to an incumbent user within a wireless network and to take certain actions to mitigate the source of interference to the incumbent user. In this manner, embodiments enable wireless networks to mitigate interference to incumbents in a more granular approach, compared to conventional AFC systems, in order to provide more optimal wireless communication performance.

Note, the techniques described herein for mitigating interference to incumbents in a wireless network may be incorporated into (such as implemented within or performed by) a variety of wired or wireless apparatuses (such as nodes). In some implementations, a node includes a wireless node. Such wireless nodes may provide, for example, connectivity to or for a network (such as a wide area network (WAN) such as the Internet or a cellular network) via a wired or wireless communication link. In some implementations, a wireless node may include a controller.

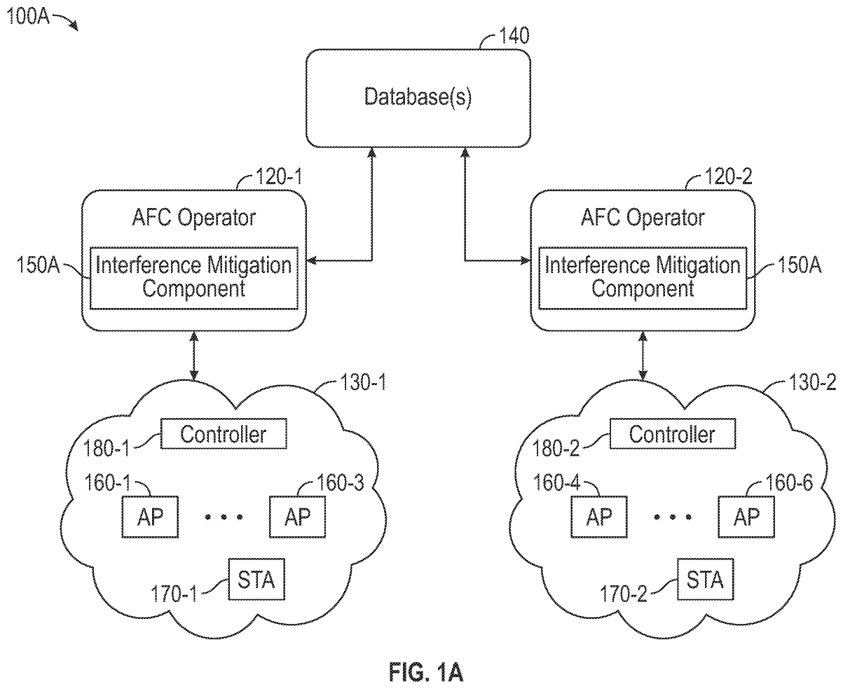

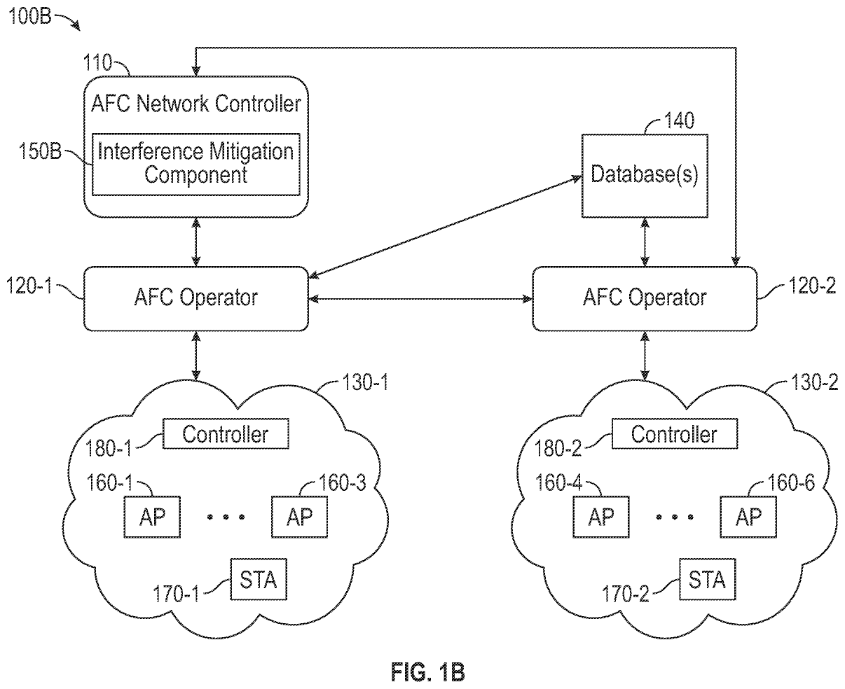

FIG. 1A illustrates an example system 100A in which one or more techniques described herein can be implemented, according to one embodiment. As shown, the system 100A includes, without limitation, an AFC operator 120-1, an AFC operator 120-2, one or more databases 140, a wireless network 130-1, and a wireless network 130-2. In certain embodiments, the wireless networks 130 1-2 support a wireless communication standard, such as WiFi 6E and WiFi 6, as illustrative, non-limiting examples.

The database(s) 140 are generally representative of regulatory database(s), which include information on incumbent users operating in the wireless networks 130. One reference example of a database 140 is the FCC ULS, which includes a list of all licensed users operating within one or more geographical areas. The database(s) 140 may be hosted on one or more computing systems (e.g., regulatory server(s)) in a cloud environment.

Each wireless network 130 1-2 may include one or more APs 160, one or more client stations (STAs) 170, or a combination thereof. Here, for example, the wireless network 130-1 includes APs 160 1-3 and client STA 170-1 and wireless network 130-2 includes APs 160 4-6 and client STA 170-2. An AP is generally a fixed station that communicates with client STA(s) and may be referred to as a base station, wireless device, or some other terminology. A client STA may be fixed or mobile and also may be referred to as a mobile STA, a client, a STA, a wireless device, or some other terminology. Note that while a certain number of APs 160 and client STAs 170 are depicted within each wireless network 130, each wireless network 130 may include any number of APs as well as any number of client STAs.

An AP 160 along with the STAs 170 associated with the AP (e.g., within the coverage area (or cell) of the AP) may be referred to as a basic service set (BSS). An AP 160 may communicate with one or more client STAs 170 on the downlink and uplink. The downlink (e.g., forward link) is the communication link from the AP to the client STA(s), and the uplink (e.g., reverse link) is the communication link from the client STA(s) to the AP. In some cases, a client STA may also communicate peer-to-peer with another client STA. Each AP 160 may include one or more radios that the AP can use to form links with one or more client STAs 170. In general, the AP 160 may form any suitable number of links for communication using any suitable frequencies or bands.

In certain embodiments, the AP(s) 160 within a given wireless network 130 may be controlled or managed at least partially by a wireless controller 180 within the wireless network 130. The management operations of such a wireless controller may be implemented by any device or system, and may be combined or distributed across any number of systems. For example, the wireless controller 180 may be a WLAN controller for the deployment of APs within the respective wireless network 130. In certain embodiments, the wireless controller 180 is implemented on one of the APs 160. In other embodiments, the wireless controller 180 is implemented as a cloud-based service.

As shown, each wireless network 130 1-2 is coupled to a respective AFC operator 120 1-2. In certain embodiments, each wireless network 130 1-2 is coupled to its respective AFC operator 120 1-2 via a respective wireless controller 180 1-2. Each AFC operator 120 is generally configured to provide its respective wireless network 130 with frequency coordination information so as to mitigate interference to incumbent users operating within the wireless network 130. For example, each AP within a given wireless network 130 may query the AFC operator 120 associated with the wireless network 130 to determine whether its operations may interfere with an incumbent user. As part of the query, the AP includes its geographical location, antenna characteristics, frequency band(s) and other deterministic parameters.

Upon receiving the query, the AFC operator 120 may consult the database(s) 140 to determine a set of wireless restrictions (also referred to as allowable wireless parameters) based on the registered/licensed use within the database(s) 140. For example, the AFC operator 120 may generate a topographical propagation map modeling the AP's interference radius, and may determine the set of allowable wireless parameters (e.g., channel settings, power settings, and other parameters), based on the topographical propagation map. The AFC operator 120 may then provide the allowable wireless parameters to the AP 160 directly or via the wireless controller 180.

In certain embodiments, each AFC operator 120 1-2 includes an interference mitigation component 150A, which is configured to implement one or more techniques described herein for mitigating interference to incumbents. For example, when interference is detected by (or reported to) a given AFC operator 120, the AFC operator 120 may use its respective interference mitigation component 150A to (i) determine the source of the interference and (ii) perform a set of actions to mitigate the interference from the source. In the embodiment depicted in FIG. 1A, the interference mitigation components 150A may operate independently from each other. In this manner, embodiments herein can provide decentralized monitoring of interference and an independent interference mitigation for a system with multiple AFC operators. Note, the interference mitigation component 150A is described in greater detail herein.

Note that while FIG. 1A depicts each AFC controller implementing a respective interference mitigation component in order to allow for decentralized interference monitoring and independent interference mitigation, in certain embodiments, the interference mitigation component can be implemented elsewhere. FIG. 1B, for example, illustrates a system 100B where the interference mitigation component is implemented in an AFC network controller 110, according to one embodiment. Compared to the system 100A, the system 10B may allow for centralized interference monitoring and interference mitigation.

As shown in FIG. 1B, each AFC operator 120 1-2 is coupled to the AFC network controller 110, which includes an interference mitigation component 150B. In certain embodiments, the AFC operators 120 1-2 are also interconnected, e.g., as shown in FIG. 1B. In this embodiment, the AFC network controller 110 may use the interference mitigation component 150B to obtain interference information from each of the AFC operators 120 1-2. The interference mitigation component 150B may evaluate the interference information to determine at least one interference source and may perform one or more mitigation actions to mitigate the interference. Note, the interference mitigation component 150B is described in greater detail herein.

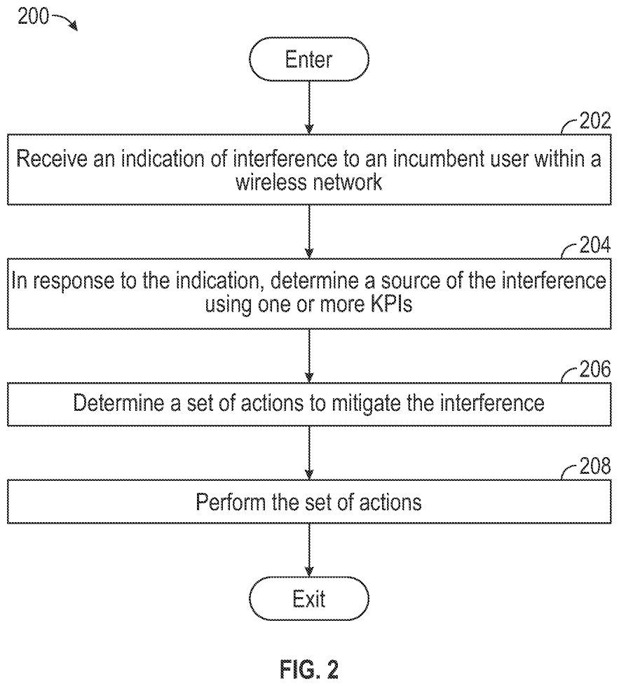

FIG. 2 is a flowchart of a method 200 for mitigating interference to incumbents in a wireless network (e.g., wireless network 130), according to one embodiment. The method 200 may be performed by an interference mitigation component (e.g., interference mitigation component 150A depicted in FIG. 1A).

Method 200 may enter at block 202, where the interference mitigation component receives an indication of interference to an incumbent user within a wireless network (e.g., wireless network 130). The interference mitigation component may receive the indication of interference from the incumbent user within the wireless network, the wireless controller (e.g., wireless controller 180), or a combination thereof. In certain embodiments, the indication of interference may include an indication of interference on one or more channels associated with the incumbent user.

At block 204, the interference mitigation component, in response to the indication, determines a source of the interference using one or more KPIs. For example, embodiments herein expose various KPIs which each AFC operator (e.g., AFC operator 120) (via its respective interference mitigation component) can employ to detect the source of interference when interference is notified.

In certain embodiments, the one or more KPIs are based on a free space path loss (FSPL) parameter(s) (or computation). In such embodiments, the interference mitigation component can compute the FSPL parameter for each AP (e.g., AP 160) operating in the indicated channel(s). Computing the FSPL parameter for each AP may enable the interference mitigation component to exclude various propagation losses associated with propagation models, such as Irregular Terrain Model (ITM), building entry loss (BEL) model, and clutter loses, as illustrative, non-limiting examples. In certain aspects, the interference mitigation component may also determine the maximum possible interference-to-noise power ratio (I/N) for a given set of APs operating in the channel(s), based at least in part on the FSPL parameters. Note, the interference-to-noise power ratio (I/N) is the ratio of unwanted signal power to total receiver system noise power (in decibels (dB)), with power levels measured in the same reference bandwidth. To determine the I/N for a given AP, the interference mitigation component may: (i) determine the thermal noise that is generated on the receiver, (ii) integrate the thermal noise in an overlapping bandwidth (e.g., the fixed service overlapping with receiver LAN (RLAN) bandwidth) to determine the noise power level, (iii) subtract the FSPL for the AP from the RLAN transmitted power level to determine the interfering signal level, and (iv) determine the I/N (in dB) as the logarithmic ratio of the noise power level and interfering signal level. In certain embodiments, the interference mitigation component may determine that the APs in the set of APs that have an I/N greater than a predefined threshold (e.g., −6 dB I/N or some other value) are the source of the interference.

In certain embodiments, the one or more KPIs include a list of APs sorted based on I/N. In such embodiments, the interference mitigation component may sort the APs from highest I/N to lowest I/N. The interference mitigation component may determine that a threshold number of the APs within the sorted list (e.g., top K out of N APs) are the source of the interference.

In certain embodiments, the one or more KPIs are based on distance from an incumbent user. In such embodiments, the interference mitigation component can sort the APs operating on the indicated channel based on distance from the incumbent user (e.g., fixed service). The APs may be sorted from lowest distance from the incumbent user to highest distance from the incumbent user. In one embodiment, the interference mitigation component may determine that a threshold number of the APs within the sorted list (e.g., top K out of N APs) are the source of the interference. In another embodiment, the interference mitigation component may determine that APs within a predetermined radius R to the incumbent user are the source of the interference.

In certain embodiments, the one or more KPIs may be based on any combination of the aforementioned embodiments. For example, in one embodiment, the one or more KPIs may be based on a list of APs sorted based on I/N and distance from an incumbent user. In this embodiment, APs are sorted based on a criterion obtained from a function of I/N and distance from the incumbent. The interference mitigation component determines that a threshold number of the APs within this sorted list (e.g., top K out of N APs) are the source of the interference.

At block 206, the interference mitigation component determines a set of actions to mitigate the interference. In one embodiment, the set of actions may include converting the set of APs that are determined to be the source of the interference from standard power (SP) operation to low power indoor (LPI) operation. In another embodiment, the set of actions may include blocking operation of the set of APs that are determined to be the source of the interference. In yet another embodiment, the set of actions may include moving one or more of the set of APs to a different channel(s) where interference has not been reported.

At block 208, the interference mitigation component performs the set of actions. In one example, the interference mitigation component converts the set of APs that are determined to be the source of the interference from SP operation to LPI operation. In another example, the interference mitigation component blocks operation of the set of APs that are determined to be the source of the interference. In yet another example, the interference mitigation component may block operation of a number of the set of APs that are determined to be the source of the interference and convert another number of the set of APs that are determined to be the source of the interference from SP operation to LPI operation. In yet another example, the interference mitigation component moves one or more of the set of APs to a different channel(s) where interference has not been reported.

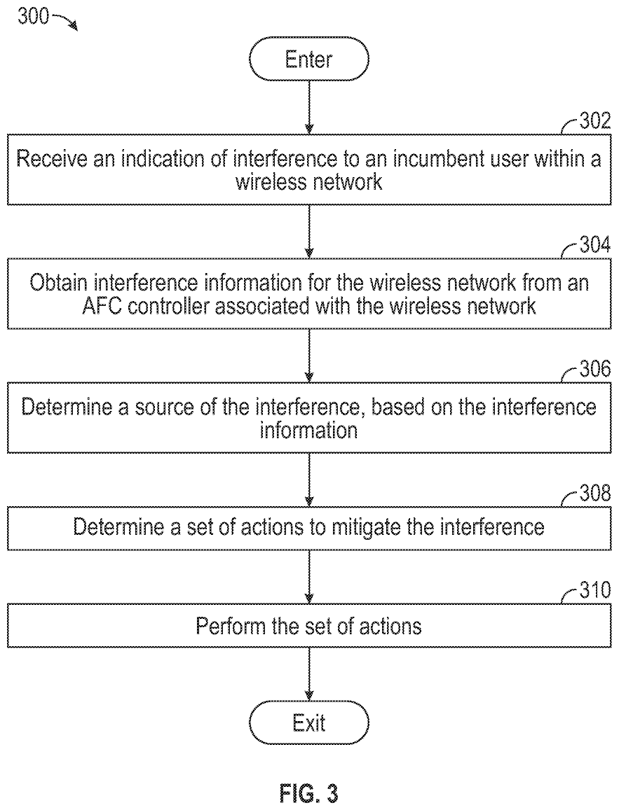

FIG. 3 is a flowchart of a method 300 for mitigating interference to incumbents in a wireless network (e.g., wireless network 130), according to one embodiment. The method 300 may be performed by an interference mitigation component (e.g., interference mitigation component 150B depicted in FIG. 1B).

Method 300 may enter at block 302, where the interference mitigation component receives an indication of interference to an incumbent user within a wireless network (e.g., wireless network 130). The interference mitigation component may receive the indication of interference from the incumbent user within the wireless network, the wireless controller (e.g., wireless controller 180), or a combination thereof. In certain embodiments, the indication of interference may include an indication of interference on one or more channels associated with the incumbent user.

At block 304, the interference mitigation component obtains interference information for the wireless network from an AFC controller associated with the wireless network. In certain embodiments, the interference mitigation component may implement a pull mechanism in order to obtain the interference information. For example, the AFC operator may expose a rest API, which can be used by the interference mitigation component (within the AFC network controller 110) to retrieve the interference information for the wireless network. The AFC operator may pull the information when interference is detected on a given channel. Alternatively, in certain embodiments, the interference mitigation component may implement a push mechanism in order to obtain the interference information. For example, the AFC operator may push the interference information periodically to the interference mitigation component (within the AFC network controller 110).

The interference information obtained in block 304 may include various KPIs. For example, in one embodiment, the interference information may include an FSPL computed I/N for each AP operating in the indicated channel(s). In another embodiment, the interference information may include a set of APs operating in the indicated channel(s) sorted based on I/N. In yet another embodiment, the interference information may include a set of APs operating in the indicated channel(s) sorted based on distance from the incumbent user.

At block 306, the interference mitigation component determines a source of the interference, based on the interference information. In one embodiment, when the interference information includes an FSPL computed I/N for each AP operating in the indicated channel(s), the interference mitigation component may determine that the APs in the set of APs that have an I/N greater than a predefined threshold (e.g., −6 dB I/N or some other value) are the source of the interference. In another embodiment, when the interference information includes a set of APs sorted based on I/N, the interference mitigation component may determine that a threshold number of the APs within the sorted list (e.g., top K out of N APs) are the source of the interference. In yet another embodiment, when the interference information includes a set of APs sorted based on distance from an incumbent, the interference mitigation component may determine that (i) a threshold number of the APs within the sorted list (e.g., top K out of N APs that are closest to the incumbent user) are the source of the interference or (ii) APs within a predetermined radius R to the incumbent user are the source of the interference. In yet another embodiment, a criterion defined based on both I/N and distance from incumbent may be used to determine the source of interference.

At block 308, the interference mitigation component determines a set of actions to mitigate the interference. For example, the set of actions may include converting the set of APs that are determined to be the source of the interference from SP operation to LPI operation. In another example, the set of actions may include blocking operation of the set of APs that are determined to be the source of the interference.

At block 310, the interference mitigation component performs the set of actions. In one embodiment, the AFC operator for the given wireless network may expose a rest API that allows the interference mitigation component to control the AP(s) within the wireless network. In one example, the interference mitigation component, via the rest API, converts the set of APs that are determined to be the source of the interference from SP operation to LPI operation. In another example, the interference mitigation component, via the rest API, blocks operation of the set of APs that are determined to be the source of the interference. In yet another example, the interference mitigation component, via the rest API, may block operation of a number of the set of APs that are determined to be the source of the interference and convert another number of the set of APs that are determined to be the source of the interference from SP operation to LPI operation.

In this manner, when interference is detected on a given channel, the AFC network controller 110 (via the interference mitigation component 150B) can consult the database(s) 140 to determine which AFC operators are using that channel, obtain interference information from the determined AFC operators, use the interference information to mitigate interference to incumbent users operating on the channel.

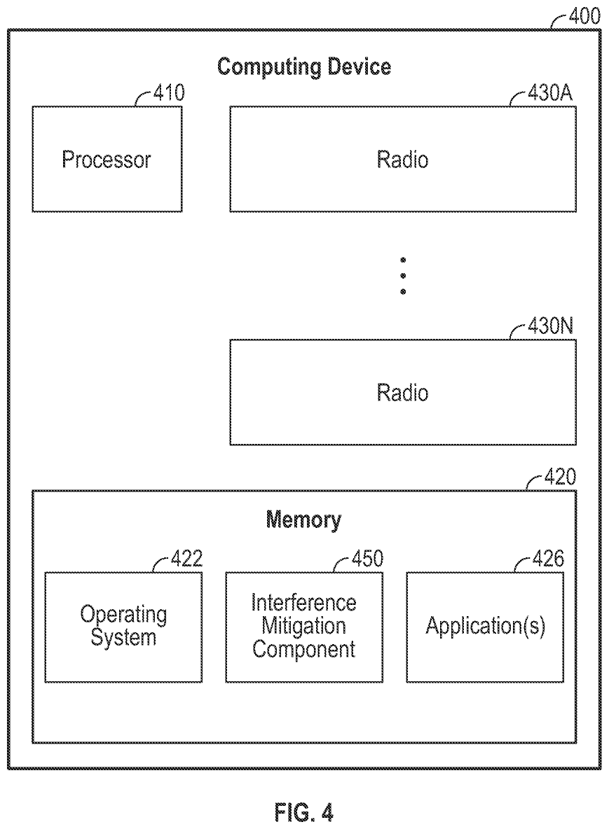

FIG. 4 illustrates an example computing device 400, according to one embodiment. The computing device 400 can be configured to perform one or more techniques described herein for mitigating interference to incumbent users within a wireless network. For example, the computing device 400 can perform method 200, method 300, and any other techniques (or combination of techniques) described herein. The computing device 400 can be an AFC operator (e.g., AFC operator 120) or an AFC network controller (e.g., AFC network controller 110). The computing device 400 includes, without limitation, a processor 410, a memory 420, and one or more radios 430a-n (generally, radio 430).

The processor 410 may be any processing element capable of performing the functions described herein. The processor 410 represents a single processor, multiple processors, a processor with multiple cores, and combinations thereof. The communication interfaces 430 facilitate communications between the computing device 400 and other devices. The communications interfaces 430 are representative of wireless communications antennas and various wired communication ports. The memory 420 may be either volatile or non-volatile memory and may include RAM, flash, cache, disk drives, and other computer readable memory storage devices. Although shown as a single entity, the memory 420 may be divided into different memory storage elements such as RAM and one or more hard disk drives.

As shown, the memory 420 includes various instructions that are executable by the processor 410 to provide an operating system 422 to manage various functions of the computing device 400. The memory 420 also includes an interference mitigation component 450 configured to perform one or more techniques described herein, and one or more application(s) 426. In one embodiment, the interference mitigation component 450 is representative of the interference mitigation component 150A. In another embodiment, the interference mitigation component is representative of the interference mitigation component 150B.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method comprising:
receiving an indication of interference on a channel that an incumbent user within a wireless network is operating on;
in response to the indication, determining a source of the interference using one or more key performance indicators (KPIs);
determining a set of actions to mitigate the interference; and
performing the set of actions.

2. The computer-implemented method of claim 1, wherein the one or more KPIs is based on a respective interference-to-noise power ratio associated with each access point (AP) of a set of APs operating on the channel, wherein each respective interference-to-noise power ratio is based on a free space path loss (FSPL) parameter associated with the respective AP operating on the channel.

3. The computer-implemented method of claim 2, wherein determining the source of the interference comprises:
sorting the set of APs based on the respective interference-to-noise power ratios; and
determining that one or more APs of the sorted set of APs that have a respective interference-to-noise power ratio greater than a predetermined threshold are the source of the interference.

4. The computer-implemented method of claim 1, wherein the one or more KPIs is based on a respective interference-to-noise power ratio associated with each access point (AP) of a set of APs operating on the channel.

5. The computer-implemented method of claim 4, wherein determining the source of the interference comprises:
sorting the set of APs based on the respective interference-to-noise power ratios; and
determining that a threshold number of the APs within the sorted set of APs are the source of the interference.

6. The computer-implemented method of claim 1, wherein the one or more KPIs is based on a respective distance to the incumbent user for each access point (AP) of a set of APs operating on the channel.

7. The computer-implemented method of claim 6, wherein determining the source of the interference comprises:
sorting the set of APs based on the respective distances to the incumbent user; and
determining that a threshold number of the APs within the sorted set of APs are the source of the interference.

8. The computer-implemented method of claim 6, wherein determining the source of the interference comprises:
sorting the set of APs based on the respective distances to the incumbent user; and
determining that one or more APs of the sorted set of APs that are within a threshold distance to the incumbent user are the source of the interference.

9. The computer-implemented method of claim 1, wherein:
the one or more KPIs are based on (i) a respective interference-to-noise power ratio associated with each access point (AP) of a set of APs operating on the channel and (ii) a respective distance to the incumbent user for each AP of the set of APs operating on the channel; and
determining the source of the interference comprises:
sorting the set of APs based on (i) the respective interference-to-noise power ratios and (ii) the respective distances to the incumbent user; and
determining that a threshold number of the APs within the sorted set of APs are the source of the interference.

10. The computer-implemented method of claim 1, wherein the set of actions comprises blocking operation of one or more access points (APs) determined to be the source of the interference.

11. The computer-implemented method of claim 1, wherein the set of actions comprises converting one or more access points (APs) determined to be the source of interference to a low power mode.

12. The computer-implemented method of claim 1, wherein the set of actions comprises blocking operation of a first one or more access points (APs) of a set of APs determined to be the source of the interference and converting a second one or more APs of the set of APs to a low power mode.

13. A computing device comprising:
one or more memories; and
one or more processors communicatively coupled to the one or more memories, the one or more processors collectively configured to perform an operation comprising:
receiving an indication of interference on a channel that an incumbent user within a wireless network is operating on;
in response to the indication, determining a source of the interference using one or more key performance indicators (KPIs);
determining a set of actions to mitigate the interference; and
performing the set of actions.

14. The computing device of claim 13, wherein:
the one or more KPIs is based on a respective interference-to-noise power ratio associated with each access point (AP) of a set of APs operating on the channel;
each respective interference-to-noise power ratio is based on a free space path loss (FSPL) parameter associated with the respective AP operating on the channel; and
determining the source of the interference comprises:
sorting the set of APs based on the respective interference-to-noise power ratios; and
determining that one or more APs of the sorted set of APs that have a respective interference-to-noise power ratio greater than a predetermined threshold are the source of the interference.

15. The computing device of claim 13, wherein the one or more KPIs is based on a respective interference-to-noise power ratio associated with each access point (AP) of a set of APs operating on the channel.

16. The computing device of claim 15, wherein determining the source of the interference comprises:
sorting the set of APs based on the respective interference-to-noise power ratios; and
determining that a threshold number of the APs within the sorted set of APs are the source of the interference.

17. The computing device of claim 13, wherein:
the one or more KPIs is based on a respective distance to the incumbent user for each access point (AP) of a set of APs operating on the channel; and
determining the source of the interference comprises:
sorting the set of APs based on the respective distances to the incumbent user; and
determining that one or more APs of the sorted set of APs that are within a threshold distance to the incumbent user are the source of the interference.

18. The computing device of claim 13, wherein:
the one or more KPIs are based on (i) a respective interference-to-noise power ratio associated with each access point (AP) of a set of APs operating on the channel and (ii) a respective distance to the incumbent user for each AP of the set of APs operating on the channel; and
determining the source of the interference comprises:
sorting the set of APs based on (i) the respective interference-to-noise power ratios and (ii) the respective distances to the incumbent user; and
determining that a threshold number of the APs within the sorted set of APs are the source of the interference.

19. The computing device of claim 13, wherein the set of actions comprises (i) blocking operation of one or more access points (APs) determined to be the source of the interference or (ii) converting one or more APs determined to be the source of interference to a low power mode.

20. A computer-implemented method comprising:
receiving an indication of interference on a channel that an incumbent user within a wireless network is operating on;
obtaining interference information for the wireless network from a controller associated with the wireless network, the interference information comprising one or more key performance indicators (KPIs) associated with a set of access points (APs) operating on the channel;
determining a source of the interference, based on the interference information;
determining a set of actions to mitigate the interference; and
performing the set of actions on one or more of the set of APs.
